(19) United States
(12) Patent Application Publication
(10) Pub. No.: US 2014/0326196 A1
(43) Pub. Date: Nov. 6, 2014

(54) Device, Set and Method for Limiting a Freedom of Movement of a Living Being

(71) Applicant: Joseph LAUSCHER, München (DE)

(72) Inventor: Joseph Lauscher, Munchen (DE)

(21) Appl. No.: 14/358,913

(22) PCT Filed: Nov. 8, 2012
(86) PCT No.: PCT/DE2012/200074

§ 371 Date: May 16, 2014

(30) Foreign Application Priority Data
Nov. 18, 2011 (DE) 10 2011 055 487.4

(51) Int. Cl. A01K 15/04

(52) U.S. Cl. CPC A01K 15/04
USPC 119/720; 119/815

(57) ABSTRACT

Embodiments of the present invention relate to a device for limiting a freedom of movement of a living being, comprising a movement limitation means attachable to the torso of the living being which may be coupled to a head of the living being by means of a coupling element, and a receiving means for a movement limitation signal, the movement limitation means being implemented to tilt and/or rotate the head of the living being with respect to the torso of the living being by means of the coupling element in response to the movement limitation signal.

### TECHNICAL FIELD

Embodiments of the present invention relate to devices and methods for limiting the freedom of movement of living beings, as they may in particular be used for limiting the mobility of animals, and here in particular of pets, like e.g. dogs.

### BACKGROUND

Animals are primarily driven by instincts and usually show an extensive need to move. In this respect, at least four-legged animals are usually clearly superior to humans with respect to their speed of movement. Dogs, for example, are very popular pets all around the world, but naturally have a very pronounced need to move and in some cases show a behavior which is unforeseeable for humans. When taking a dog for a walk, which is generally also referred to as “going walkies”, again and again situations occur in which even a well-educated or trained dog unexpectedly or unwantedly leaves the side of its human owner. Such a behavior of the dog may, for example, be caused by other dogs, animals or humans in its proximity. A frequently observed behavior is, for example, the dogs spontaneously racing towards each other or away from each other. This in particular takes place if the animals are not lead on a leash by their owners and may thus move around freely. The consequences of such spontaneous solo runs may, for example, be bitings or dogfights, attacks on people or traffic accidents which may in some cases lead to severe physical, psychological and/or financial damages of all involved parties. Also other unpleasant situations involving other pets and/or domestic animals, like e.g. horses, cows, etc. are well conceivable.

In some situations, like e.g. in the above-described cases, it would thus be desirable to limit the range of movement of the animals in time in order to thus be able to keep them from running away uncontrolled or to stop them. Due to the mentioned physical superiority of many animals with respect to humans this is hardly possible, however, without technical aids, as people are usually too slow and/or weak to hold back the animals or catch up with them.

To limit the freedom of movement of grazing animals and keep them from running away, borders are used for grazing land, for example, which in some cases carry electrical voltage to give the animals a relatively weak but frightening electrical shock.

In particular for dogs electric collars a known which may be used to “educate” the animal and teach it obedience. A wrong behavior of the dog, like e.g. barking too loud and moving away from the owner without permission may be punished using a little electrical shock. In some cases the dog may be kept from misbehaving, but such an approach is controversial and to be refused from the point of view of animal-rights activists. An electrical collar uses stimulation current. Manufacturers of electrical collars assume that the collar causes no danger at all for the animal as the current strength is set to be very low. Still it means pain for the dog, however, which it may not even allocate. Apart from that, it may not be securely be prevented that the animal runs away, in particular if the “stimulus or attraction of running away” is greater for the dog than the relatively humble electric shock.

A further means in particular used for educating dogs is the so-called spray collar. Unwanted behavior of the animal may be treated using the same, like e.g. jumping up on people, hunting or chasing other animals, nibbling at objects or trying to run away. A spray collar is painless for the animal by giving off a spray burst which is unpleasant for the animal. In this respect, the spray collar is filled with a non-poisonous liquid which is unpleasant for the animal. When the animal misbehaves, the spray collar may be activated and a spray burst may be given off. The animal is thus distracted and usually favors the proximity of its owner. The spray collar does not offers a remedy for the misbehavior of the animal either, however, in particular when comparatively mild liquids are used which the animal may even get used to.

It is thus the object of the present invention to provide an improved concept for limiting unwanted actions of an animal, in particular with respect to the animal running away unwantedly.

### SUMMARY

Embodiments of the invention are based on the finding that the freedom of movement or the need to move of a living being, in particular of an animal, may among others be limited by limiting the visual field. If an animal cannot see clearly where it is moving it will not feel a pronounced urge to move but rather keep still or stop moving.

It is a further finding that the limitation of the visual field may be acquired by a tilting of the head of the animal with respect to its torso. “Tilting” in the following includes bowing, rising or rotating of the head. In particular by tilting down or bowing the head in the direction of the torso the visual field of the animal towards the front may be limited. With its head bowed down in the direction of its torso or breast and it additionally being fixed in this position, the animal will feel no urge to run away.

As the animal will usually not bow its head on command with respect to its torso in order to limit its visual field and thus reduce its urge to move, embodiments of the present invention provide technical means which may be fastened or strapped to the animal for example using correspondingly configured harnesses or the like.

Embodiments of the present invention provide a device for limiting the freedom of movement of a living being, in particular of an animal. For this purpose, the device comprises movement limitation means attachable to the torso of the animal which may be coupled to the head of the living being by means of a coupling element and may thus cooperate with the same. The movement limitation means here comprises means for limiting the freedom of movement of the living being. Further, the device comprises a receiving means for a movement limitation signal. According to embodiments, the movement limitation means is configured to tilt the head of the living being with respect to its torso in response to the received movement limitation signal. Here, according to some embodiments, “tilting the head” also means “lowering the head”, “turning the head”, or “rising the head”, i.e. a movement of the head with respect to the torso.

For this purpose, the device for limiting the freedom of movement may be attached to the animal or living being itself. Mass and weight of the device for limiting the freedom of movement are preferably kept within corresponding boundaries or are so low that the device attached to the animal (in the deactivated state of the device) impedes the animal as little as possible.

According to some embodiments, the movement limitation means may, for example, be attached to the chest area of the animal by means of a chest harness provided for this purpose, so that the movement limitation means may be attached to the bottom side of the torso of a four-legged animal, like, for example, a dog, in an area between forelegs and hind legs, preferably at the chest. For mounting or attaching the movement limitation means to the torso, either especially provided holding devices or also conventional, commercially available chest harnesses may be used.

The movement limitation means and/or the coupling element coupled to the same may be driven by means of an actuator. An actuator, also referred to as an actor, may convert the movement limitation signal received by means of the receiving means into a mechanical movement at least of individual parts of the movement limitation means. This means that according to embodiments the actuator is configured to convert the received movement limitation signal, by means of the coupling element between the movement limitation means and the head, into a mechanical movement by which a force is exerted onto the head of the animal to tilt the head of the animal with respect to its torso. Depending on the coupling element used for a transmission of power between the movement limitation means and the head, basically a plurality of actuator principles is possible.

According to some embodiments of the device for limiting the freedom of movement, the movement limitation means comprises an electric motor as an actuator which may be accommodated in a housing of the movement limitation means. Electric motors are available on the market in a series of sizes and implementations. They may be operated easily using batteries and/or rechargeable accumulators which enables a relatively simple handling of the device for limiting the freedom of movement and apart from that leads to a virtually unrestricted mobility or portability.

According to some embodiments of the present invention, the movement limitation means is configured to pull the head of the animal in the direction of the torso of the animal or its chest by means of the actuator and the coupling element in response the received movement limitation signal in order to tilt or bow down the head and thus limit the visual field of the animal towards the front. In principle, using the movement limitation means also other tilting directions are possible, for example to the side. If the animal is forced to look down by tilting the head correspondingly, it may be prevented from running away uncontrolled. The actuator of the movement limitation means, for example an electric motor, may for this purpose for example be provided with an electro-motively driven rope winch to wind up a rope onto a drum of the rope winch in response to the received movement limitation signal, the rope being a coupling element between the movement limitation means and the head or a head harness attached to the same, in order to actively pull the head of the animal in the direction of the torso. Also rope winches driven by (electric) motors are common members readily available on the market in virtually all sizes and designs and thus allow a cost-effective realization of the movement limitation means.

Of course, the actuator or its mode of action ought to be adapted to the coupling element operating between the movement limitation means and the head of the animal. Although in preferred embodiments of the invention which may, for example, be used for limiting the freedom of movement of dogs, a rope or a rope-like element, like e.g. a belt, may be provided as a coupling element, of course also different implementations of the coupling element between the movement limitation means and the head are possible which are able to cause a tilting of the head. In particular different implementations of chains or rods, bars or rod linkages are to be mentioned which may be adapted to the anatomy of the living being regarding their shape. For fastening the coupling element to the head of the animal, e.g. corresponding head harnesses may be provided. With some implementations, the coupling element—like e.g. a rope or a rod—may also cooperate with a nose ring, as it may be advantageous with cows, for example.

In particular to have the possibility to let an animal provided with the device run around freely, it is appropriate to receive the movement limitation signal wirelessly using the receiving means. The receiving means may thus be configured to wirelessly receive the movement limitation signal. The receiving means may, for example, be a receiver for radio signals or other wireless (like e.g. optically transmitted) signals. Further, according to embodiments, the receiving means may be integrated in a common housing with the movement limitation means which makes the portable device for limiting the freedom of movement especially compact and easy to handle.

In this respect, the receiver may comprise analog and/or digital circuit parts coupled to a receiving antenna which downmix the (modulated) movement limitation signal from a transmission band, like e.g. the license-free (public domain) 2.4 GHz band, if applicable via an intermediate-frequency stage, into the digital baseband in which a digital signal processing and evaluation may be executed.

Accordingly, embodiments of the present invention further provide a transmission means for the movement limitation signal on the remote side with respect to the receiving means, like e.g. a remote control, which may send out wireless control signals for the movement limitation means. Such wireless control signals may be based on application-specific transmission mechanisms. Preferably, the movement limitation signal is transferred, however, between the transmitting and receiving means according to a wireless standard transmission method which may be based on a multiplexing method, like e.g. Time Division Multiple Access (TDMA), Frequency Division Multiple Access (FDMA), Code Division Multiple Access (CDMA), Space Division Multiple Access (SDMA), or combinations of the different multiplexing methods. According to some embodiments, thus also mobile telephone may serve as a remote control being a control signal generator for the device for limiting the freedom of movement.

Implementing the movement limitation signal as a modulated radio signal transmitted by means of a multiplexing method is in particular advantageous if a differentiation between a plurality of movement limitation means is desired with are each specific for a living being or animal. This will have to be assumed in practice, as in particular in urban or city areas many dogs are being taken for a walk at the same time (e.g. in a city park). By the transmission of the movement limitation signal by means of a multiplexing method, specific signal sequences may each be allocated to the different animals or their movement limitation means, so that the movement limitation means each only react to their allocated signal sequences. Code Division Multiple Access (CDMA) may here be regarded as especially advantageous, wherein a specific so-called spread code is allocated to each movement limitation means for one animal. The Code Division Multiple Access method is a multiplexing method which enables the simultaneous transmission of different payload data streams on the same frequency range. A main characteristic of the commonly used frequency range is a larger bandwidth than the one occupied by the payload data stream. For frequency spreading and for differentiating the different data streams, special spread codes are used. For example, the device may operate in the license-free 2.4 GHz band.

To protect the living being for which the device for limiting the freedom of movement is used from injuries, the movement limitation means may comprise a force-limiting element to reduce a maximum force, in particular a tensile force, exerted onto the head of the living being by the actuator or the movement limitation means to a minimum. Different animals require different forces to be able to actually tilt the head of the animal or pull it into the direction of its torso. For a small dog, for example, a smaller tensile force will be required than for a comparatively large dog, like e.g. a German shepherd or a Great Dane. The same applies if embodiments of the present invention are used with large animals, like e.g. horses, cows, etc.

It is thus obvious that the movement limitation means or its actuator and also the coupling element preferably ought to be adapted to a size and strength of the living being for which embodiments of the device for limiting the range of movement or mobility are to be used. This may be done in different ways. In this respect, for example, spring elements and/or stops may be provided for adapting the device to certain animals. Thus, the force-limiting element may be configured to adapt the maximum tensile force of the movement limitation means to a size and/or muscle power of the living being. For this purpose, as a force-limiting element, for example, a slip clutch may be provided which is coupled to the actuator (e.g. electric motor with rope winch). In general, a slip clutch is arranged between two shafts. When reaching a defined torque the slip clutch will connect or disconnect without any external, i.e. outside, influence. Thus the shafts, apart from running at even speed, may also run at a different rotational speed, up to the standstill of one of the shafts. Basically, slip clutches may be used where injuries of living beings are to be prevented. For example, slip clutches may be used as a protective measure, as they slip through when reaching a maximum load.

Additionally or alternatively, the movement limitation means may also comprise a control or regulating means in order to control and/or regulate an extent of tilting the head, like e.g. lowering the head in the direction of the torso. According to some embodiments, the control or regulating means may be configured such that it always adapts a tensile force exerted on the head to a counteracting force exerted by the animal, so that when lowering the head the tensile force of the movement limitation means is greater than the counteracting force exerted by the animal, and that in case of a completely lowered state of the head a balance of forces exists between the two counteracting forces. If the head is to be released again, the tensile force may either be suddenly eliminated or be slowly reduced to zero. An electronic and/or mechanical control of the tensile force exerted by the movement limitation means may be used in a very gentle and pleasant way for the animal for limiting its freedom of movement.

Of course, apart from limiting the freedom of movement, embodiments should also allow the reestablishment or enabling of the freedom of movement. For this purpose, the receiving means is configured to also receive a movement enable signal in addition to the movement limitation signal. The movement limitation means is configured, in response to the received movement enable signal which—just like the movement limitation signal—may be a correspondingly modulated radio signal, to again release the head of the animal which is tilted with respect to the torso by the movement limitation means and thus limited in its movements. As already indicated above, this may be done by gently reducing the tensile force. In some embodiments, the electro-motively operated rope winch may be released so that the rope (coupling element) may unwind again.

It may further be advantageous to limit or restrict an animal in its freedom of movement depending on a distance between the movement limitation means and a remote control for transmitting the movement limitation signal. In order to enable this, embodiments of the device may additionally include a means for determining the distance between the movement limitation means and the remote control for transmitting the movement signal. The means for determining the distance may additionally be configured to indicate the distance to the animal and/or a direction in which the animal is located to the owner of the animal, to enable the owner to locate the animal. The determination of the distance may, for example, be done by evaluating signal run times and/or field strength measurements with respect to the movement limitation signal and/or the movement enable signal. Further, for determining the position, a corresponding navigation hardware, like e.g. a GPS receiver (GPS=Global Positioning System), may be provided in the movement limitation means.

In order to prevent the animal from going away more than a predetermined value or more than a maximum distance from its owner or another predefined location, according to some embodiments, the movement limitation signal may be triggered as soon as a determined distance between the location of the animal and the owner or the other predefined location exceeds a pre-determinable maximum distance. The means for determining the distance may additionally be configured to trigger the movement limitation signal in response to a determined distance between the movement limitation means and the remote control being greater than the pre-determinable maximum distance. Thus, embodiments so to speak allow a pre-determinable area of location of the animal which is defined, for example, by the pre-determinable maximum distance and the position of the remote control. If the animal tries to leave this area of location or range of movement, the movement limitation signal is triggered, whereupon the head of the animal may be tilted with respect to its torso by the movement limitation means in order to bring the animal to a stop.

Further embodiments of the present invention not only include the above described device for limiting the freedom of movement but rather also a whole set for limiting the freedom of movement of a living being, the set comprising a device for limiting the freedom of movement according to embodiments of the present invention. Further, the set includes a head harness attachable to the head of the animal which comprises a coupling means for the coupling element. Apart from that, the set also comprises a remote control for triggering the movement limitations signal or the movement enable signal.

According to a further aspect of the present invention, a method for limiting the freedom of movement of a living being, in particular an animal, is provided. Here, the method includes a step of transmitting a movement limitation signal to a respective receiver of a movement limitation means attached to the torso of the animal, the means being coupled to the head of the animal by a coupling element. Further, the method includes a step of tilting, in response to the movement signal, the head of the animal with respect to its torso by means of the movement limitation means and the coupling element.

Compared to devices and methods currently known in the prior art, embodiments of the present invention enable a more humane concept which is improved regarding its effectiveness, for limiting the range of movement a living being, in particular an animal, on command, i.e. by the movement limitation signal, i.e. for example to make it stop or keep it from running away. It may even be possible to not only make the animal stop on command or based on a pre-determinable radius of movement by means of the remote control but to even give the animal and the movement limitation means further or extended movement commands like, e.g., “left”, “right” etc.

### BRIEF DESCRIPTION OF THE DRAWINGS

In the following, some embodiments of the present invention are explained in more detail with reference to the accompanying drawings, in which:

FIG. 1 is a schematical block diagram of a device for limiting the freedom of movement of a living being according to one embodiment of the present invention;

FIG. 2 is one possible implementation of the device for limiting the freedom of movement according to FIG. 1;

FIG. 3 is a schematical illustration of a dog wearing a device for limiting its freedom of movement according to one embodiment;

FIG. 4 is a schematical illustration of the dog according to FIG. 3 with a limited freedom of movement limited by the device for limiting the freedom of movement; and

FIG. 5 is a schematical flow chart of a method of limiting a freedom of movement of a living being according to one embodiment of the present invention.

### DETAILED DESCRIPTION

Within the scope of the present specification, summarizing reference numerals are used for objects, structures and other components, if the corresponding component per se or several corresponding components are described within one embodiment or within several embodiments. Passages of the description relating to one component may thus also relate to other components in other embodiments, as far as this is not explicitly excluded or clearly results from the context. If individual components are designated, individual reference numerals are used which may be based on the corresponding summarizing reference numerals. In the following description of embodiments, like reference numerals refer to like or seemingly like components.

Components which occur several times in one embodiment or in different embodiments may here be implemented or designed identically and/or differently with respect to some of their technical parameters. It is thus possible, for example, that several components within one embodiment are implemented identically with respect to one parameter, but differently with respect to another parameter.

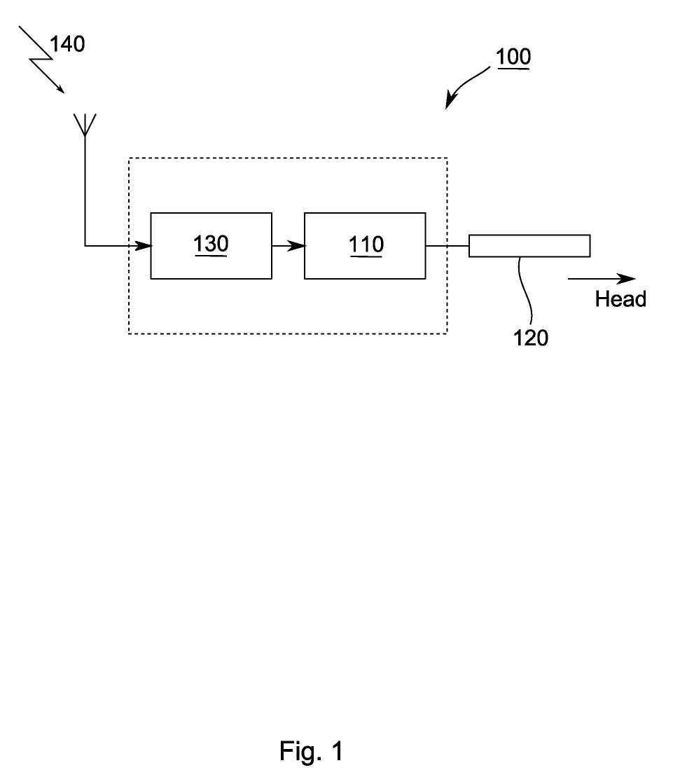

FIG. 1 shows a schematical illustration of a block diagram of a device 100 for limiting a freedom of movement of a living being, also designated as a movement limitation device 100 in the following.

The movement limitation device 100 comprises a movement limitation means 110 attachable to the torso of the living being, e.g. an animal. The movement limitation means 110 may further be directly or indirectly coupled to the head of the living being by means of a coupling element 120. The head of the living being may thus be coupled to the device 100 or its movement limitation means 110 by means of the coupling element 120. Further, the device 100 for limiting the freedom of movement includes a receiving means 130 to be able to receive a movement limitation signal 140. The device 100 or the movement limitation means 110 is implemented to tilt the head of the living being with respect to the torso of the living being by means of the coupling element 120 in response to the received movement limitation signal 140.

Tilting the head is based on a cooperation of the movement limitation signal 140 received by the receiving means 130, the movement limitation means 110 and the coupling element 120 arranged between movement limitation means 110 and the head of the living being. For this purpose, the received movement limitation signal 140 may, for example, act upon an electro-mechanical actuator of the movement limitation means 110 which is not illustrated in FIG. 1 but which in turn operates the coupling element 120 such that using the same a force is transferred onto the head of the living being. This force which is exerted on the head forces the living being to tilt its head with respect to its torso. Although it is basically possible to tilt the head in different directions, some embodiments of the present invention relate to a tilting of the head towards the torso or in the direction towards the chest of the animal. Thus, this means that in some embodiments the movement limitation means 110 driven by an actuator may act upon the coupling element 120 such that by means of the coupling element 120 a tensile force is exerted onto the head in the direction of the torso or chest of the living being.

According to preferred embodiments, the movement limitation device 100 with its illustrated components is implemented as a portable device for the living being. Thus, the device 100 may be mounted to the body of the living being in order to limit the same with respect to its freedom of movement during movement and on command (=movement limitation signal 140) by exerting a (tensile) force onto the head. It is thus advantageous if the movement limitation signal 140 is transmitted wirelessly, e.g. by means of radio transmission, from a transmitter (not illustrated in FIG. 1) to the receiving means 130. The receiving means 130 may thus be implemented as a mobile or portable receiver in order to wirelessly receive the movement limitation signal 140.

As already mentioned above, there is a plurality of possible different radio technologies for a wireless transmission technology which are chosen depending on different factors like, e.g., stability against interferences, number of devices, available frequency band etc. Without limitation of generality and only exemplarily, CDMA is to be mentioned here as a very versatile transmission method, so that, according to some embodiments, the receiving means 130 may be implemented to receive a modulated frequency spread signal with a spread code which is specific for the living being or the device 100 as the movement limitation signal.

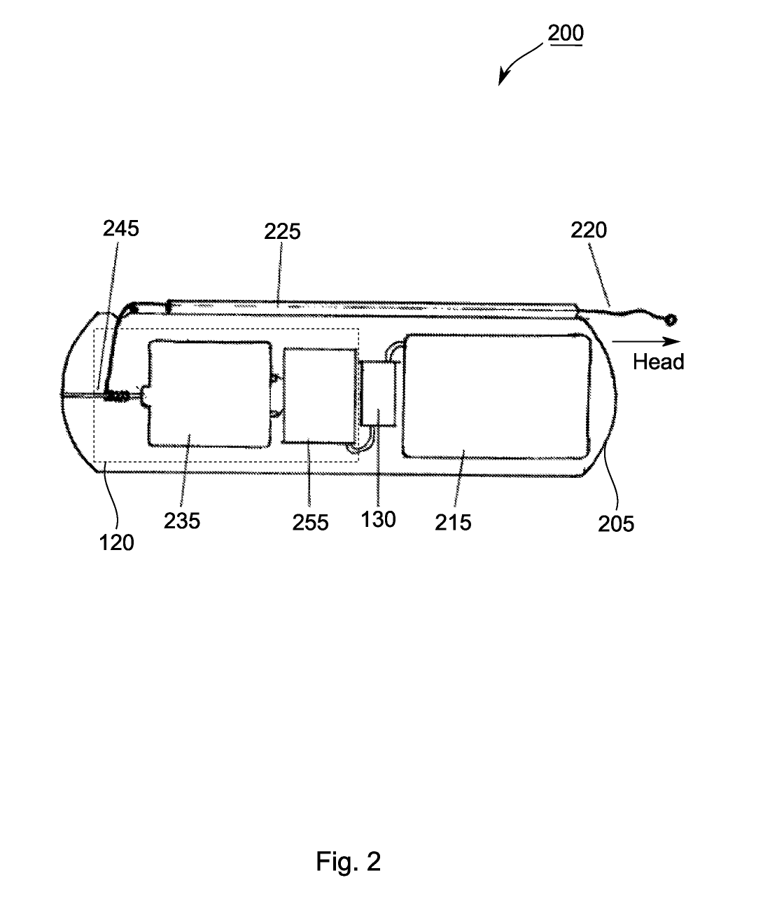

After the general setup and the general functionality of the movement limitation device 100 have been explained with reference to the schematic diagram of FIG. 1, in the following, with reference to FIGS. 2 to 4, one possible embodiment 200 of the movement limitation device 100 is to be described. It is obvious here, that the described embodiment is only one of many possible realizations of the invention and that the same is not to be regarded as limiting the scope of the invention.

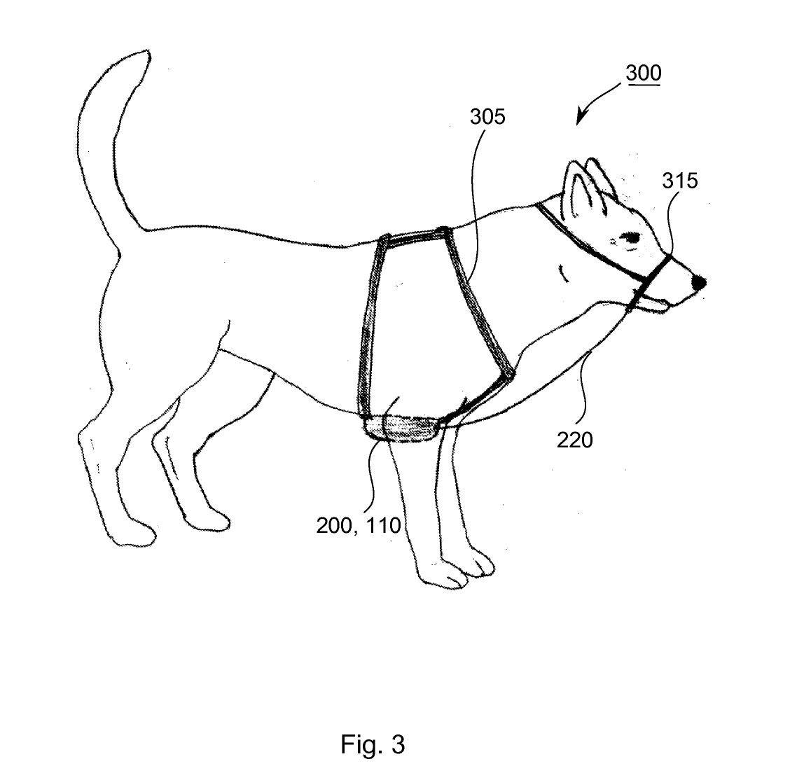

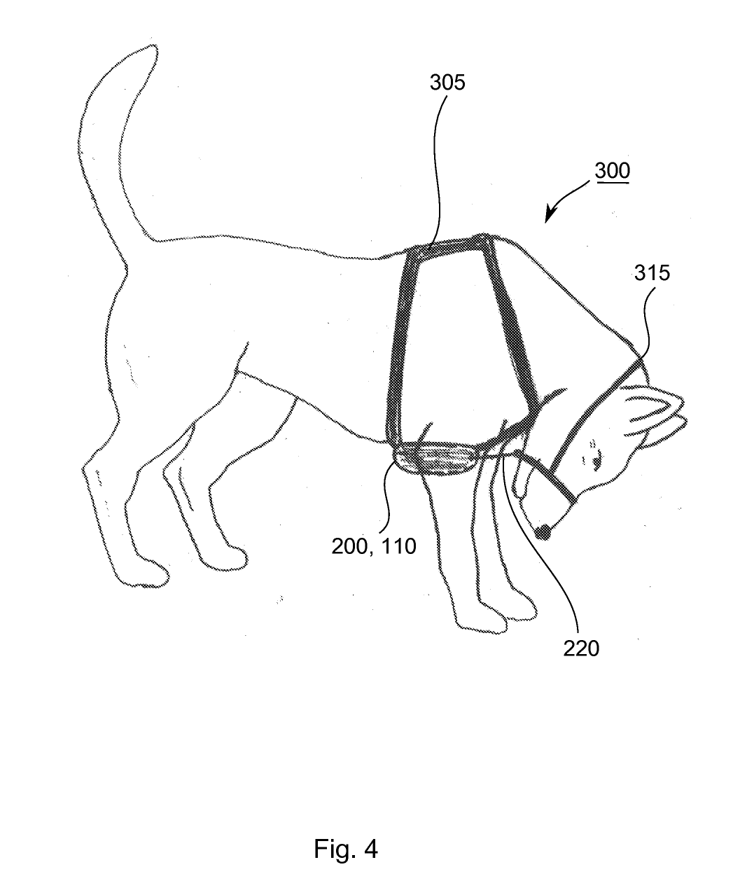

FIG. 2 shows one embodiment of a device 200 for limiting a freedom of movement of an animal, in particular a dog. As it is illustrated schematically in FIGS. 3 and 4, the device 200 may be attached to a chest area of the dog 300 by means of a chest harness 305. The movement limitation device 200 is accordingly implemented as small or limited as possible with respect to size and weight in order to make wearing the device 200 as pleasant and as little burdensome as possible for the dog 300.

According to the embodiment illustrated in FIG. 2, the movement limitation device 200 comprises a housing 205 in which the movement limitation means 110 (=means for limiting the range of movement), the receiving means 130 and an energy storage 215 are arranged. In the embodiment illustrated in FIG. 2, the movement limitation means 110 may be coupled or connected to the head of the dog 300 by means of a rope 220 as a coupling element 120. On the side of the head, the rope 220 may, for example, be connected to the head of the dog 300 by means of a head harness 315. In this respect, the rope 220 may, for example, be fastened to the head harness 315 below the snout or nose of the animal 300 (see FIGS. 3, 4). For a better guiding of the rope 220, the same may be guided in a guide housing 225 which passes along the device housing 205. The guide housing 225 may, for example, be a tube or a guiding which is at least partially tube-shaped.

For exerting a force onto the head of the dog, the rope 220 may be wound onto and off a rope winch 245 driven by means of an electric motor 235 acting as an actuator. The movement limitation means 110 thus comprises an electromotively driven rope winch 245 to roll or wind the rope 220 onto a drum or bar of the rope winch 245 in response to the movement limitation signal 140 received by means of the receiving means 130 and thus pull the head of the dog 300 in the direction of its torso, as it is schematically illustrated in FIG. 4. While FIG. 4 shows the dog 300 with its head tilted in the direction of its chest (the rope 220 is here wound onto the rope winch 245), FIG. 3 shows the dog 300 with a normal or unlimited freedom of movement (the rope 220 is here wound off the rope winch 245).

The movement limitation device 200 receives its energy from the energy storage 215 which is implemented as a battery or a rechargeable accumulator in the illustrated embodiment in order to provide the receiver 130 and the movement limitation means 110 including the electric motor 235 with electric energy, i.e. current and/or voltage. Between the receiver 130 for the movement limitation signal 140 and the electric motor 235 a regulating or control means 255 may be connected, e.g. in the form of a so-called speed controller. The regulating or control means 255 regulates or controls the electric motor 235 in response to signals received from the receiving means 130. As an input signal, the speed controller 255 e.g. receives impulses from the receiver 130 which it may, for example, convert into a pulse-width modulated (PWM) signal for the electric motor 235. In a comparatively simple implementation, the regulating or control means 255 may cause only two different rotary movements of the electric motor 235. A first one in order to wind up the rope 220 onto the rope winch 245 in response to the movement limitation signal 140 and thus cause a tensile force to be exerted onto the head of the dog 300 for limiting the range of movement (see FIG. 4). In response to a second signal, a movement enable signal, a direction of rotation and a rotational speed of the electric motor 235 may be set in order to unwind the rope 220 from the drum of the rope winch 245 and thus enable an unlimited way of movement for the dog 300 (see FIG. 3). For this purpose, the receiving means 130 may be implemented to also receive the movement enable signal in addition to the movement limitation signal 140. The movement limitation means 110 is accordingly implemented, in response to the movement enable signal, to release the head of the dog 300 again (in an upward direction) which had been pulled in the direction of the torso and thus limited with respect to movement.

According to other embodiments, the regulating or control means 255 may also be implemented more complex. It may, for example, also be implemented to control and/or regulate an extent of lowering the head of the dog 300 in the direction of its torso, i.e. to actually perform a target/actual comparison. The term “extent” here e.g. relates to an extent of the downward tilting angle of the head. The tilting angle of the head indirectly results from how far the rope 220 is wound onto the drum of the rope winch 245. Additionally or alternatively, the term “extent” may also be regarded as a force which pulls the rope 220 or the head of the dog 300 in the direction of its torso. In other words, the regulating or control means 255 may also be used for regulating or controlling a rotational speed and/or torque of the electric motor 235 in order to be able to adapt the force exerted by the rope 220 to a size and/or muscle power of the dog 300 (or another animal).

It may further be advantageous to provide means for limiting the force exerted onto the head of the dog 300 or animal. Such means may, for example, be provided by the control or regulating means 255 which may regulate a force exerted onto the animal 300 by means of a control loop to a required magnitude so that the force is always sufficiently high and at the same time sufficiently low in order not to injure the animal. In other embodiments, a force limitation but also a different, e.g. mechanical, force-limiting element may be realized. Thus, for example, the maximum force exerted onto the animal may be adapted by means of a slip clutch to a size and/or muscle power of the animal 300 in order not to unnecessarily injure the animal. In preferred embodiments, the movement limitation means 110 may thus comprise a force-limiting element (for example an electronic control or a mechanical clutch) in order to limit a maximum force in general exerted onto the head of the animal by the electro-mechanical actuator 235 and/or the movement limitation means 110

As already mentioned above, embodiments of the present invention may be extended by further useful functions, like, e.g., a distance determination between the movement limitation device 200 and a remote-side remote control for transmitting the movement limitation and movement enable signals. A determined distance may then again be used, if applicable, to trigger a movement limitation signal or a movement enable signal. If the dog 300 for example moves out of the maximum admissible radius around the remote control, the movement limitation signal 140 may automatically be triggered in order to bring the dog 300 to a halt. Only when the distance between owner or remote control and dog 300 is small enough again will the movement enable signal be triggered in order to let the dog 300 run around freely again.

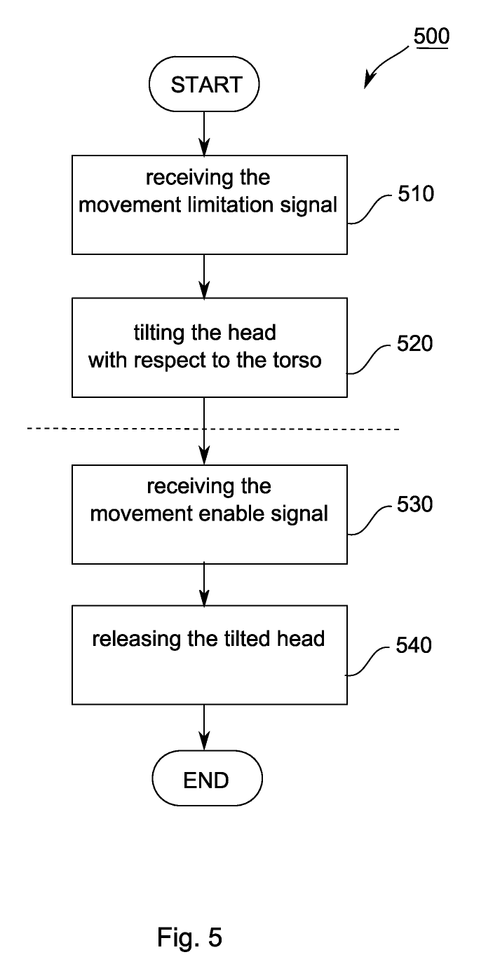

The concept presented herein is summarized again with reference to FIG. 5 now.

FIG. 5 schematically illustrates a flow chart of a method 500 for limiting a freedom of movement of basically any living being, but which is preferably from the group of mammals and further preferably from the group of pets/livestock kept or owned by humans. The method 500 includes a step 510 of transmitting the movement limitation signal 140 from a remote control to a receiver 130 of a movement limitation means 110 attached to the torso of the living being 300 which is coupled to the head of the living being 300 by means of a coupling element 120. In response to the movement limitation signal 140, in a step 520 the head of the living being 300 is rotated or tilted, in particular lowered, with respect to its torso by means of the movement limitation means 110 and the coupling element 120.

In order to restore the unlimited freedom of movement of the living being, in a further step 530 a movement enable signal may be transmitted from the remote control to the receiver 130. In response to the received movement enable signal, the force exerted upon the head of the living being by means of the movement limitation means 110 and the coupling element 120 may be released again in order to restore the freedom of movement of the living being.

Depending on certain implementation requirements, embodiments of the present invention may also be implemented with the help of corresponding software. The implementation may be executed using a digital storage medium, e.g. a floppy disk, a DVD, a blue-ray disk, a CD, an ROM, a PROM, an EPROM, an EEPROM or a FLASH memory, a hard disk or another magnetic or optical memory on which electronically readable control signals are stored which may cooperate or do cooperate with a programmable hardware component such that a method for movement limitation is executed.

A programmable hardware component may be formed by a processor, a computer processor (CPU=Central Processing Unit), a computer, a computer system, an application-specific integrated circuit (ASIC), an integrated circuit (IC), a system on chip (SOC), a programmable logic element or a field programmable gate array having a microprocessor (FPGA).

The digital storage medium may thus be machine-readable or computer-readable. Some embodiments thus include a data carrier comprising electronically readable control signals which are able to cooperate with a programmable computer system or a programmable hardware component such that one of the methods described herein is executed, or at least some steps of the same. One embodiment thus is a data carrier (or a digital storage medium or a computer readable medium) on which the program for executing one of the methods described herein is stored.

In general, embodiments of the present invention may be implemented as a program, as firmware, as a computer program or computer program product having a program code, or as data, wherein the program code or the data is operable to execute one of the methods when the program is executed on a processor or a programmable hardware component. The program code or the data may, or may for example, also be stored on a machine-readable carrier or data carrier. The program code or data may be available as source code, machine code, byte code or another form of intermediate code.

A further embodiment is further a data stream, a signal sequence or a sequence of signals which represent the program for executing one of the methods described herein. The data stream, the signal sequence or the sequence of signals may, for example, be configured to be transferred via a data communication connection, for example via the internet or another (wireless) network. Embodiments thus also are data-representing signal sequences suitable for being transmitted via a network or a data communication connection, wherein the data represents the program.

A program according to one embodiment may implement one of the methods while being executed, for example by reading out memory locations or writing one datum or several data into the same, whereby switching processes or other processes may be caused in transistor structures, in amplifier structures or in other electric, optic or magnetic components or in components operating according to another functional principle. Accordingly, by reading out a memory location, data, values, sensor values or other information may be detected, determined or measured by a program. By reading out one or several memory locations, a program may thus detect, determine or measure magnitudes, values, measured quantities and other information, as well as cause, trigger or execute an action or operation by writing into one or several memory locations and control other devices, machines and components.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

### REFERENCE NUMERALS LIST

100 device for limiting a freedom of movement according to a first embodiment

110 movement limitation means

120 coupling element

130 receiving means

140 movement limitation signal

200 device for limiting a freedom of movement according to a further embodiment

205 housing

215 energy storage, accumulator

220 coupling element, rope

225 guide tube

235 electric motor

245 electromotively operated rope winch

255 regulating and control means, speed controller

300 living being, dog

305 chest harness

315 head harness

500 method of limiting a freedom of movement according to one embodiment

510 transmitting the movement limitation signal to the receiver

520 tilting the head of the living being by means of the movement limitation means and the coupling element in response to a movement limitation signal

530 transmitting the movement enable signal to the receiver

540 releasing the force exerted onto the head of the living being in response to the movement enable signal

1. A device for limiting a freedom of movement of a living being, comprising:
a movement limitation means attachable to the torso of the living being and coupleable to a head of the living being by means of a coupling element; and
a receiving means for a movement limitation signal;
the movement limitation means being implemented to tilt and/or rotate the head of the living being with respect to the torso of the living being by means of the coupling element in response to the movement limitation signal.

2. The device of claim 1, wherein the movement limitation means is configured to pull the head of the living being in the direction of the torso of the living being by means of the coupling element in response to the movement limitation signal.

3. The device of claim 1, wherein the movement limitation means is attachable to a chest area of the living being by means of a chest harness.

4. The device of claim 1, wherein the movement limitation means comprises an actuator to drive the movement limitation means and/or the coupling element and thus exert a force onto the head of the living being.

5. The device of claim 4, wherein the actuator is an electric motor.

6. The device of claim 1, wherein the receiving means is configured to wirelessly receive the movement limitation signal.

7. The device of claim 6, wherein the receiving means is configured to receive a modulated radio signal as a movement limitation signal, in particular a frequency spread signal with a spread code which is specific for the living being.

8. The device according to claim 1, wherein the coupling element is a rope coupled to the head, and wherein the movement limitation means comprises an electromotively driven rope winch to wind the rope onto a drum of the rope winch in response to the movement limitation signal and thus pull the head of the living being in the direction of its torso.

9. The device according to claim 1, wherein the movement limitation means comprises a force-limiting element to limit a maximum tensile force exerted onto the head of the living being by the actuator and/or the movement limitation means.

10. The device according to claim 9, wherein the force-limiting element is configured to adapt the maximum tensile force of the movement limitation means to a size and/or muscle power of the living being.

11. The device according to claim 1, wherein the movement limitation means comprises a control or regulating means to control and/or regulate an extent of tilting and/or rotating the head with respect to the torso.

12. The device according to claim 1, wherein the receiving means is configured to additionally receive a movement enable signal, and wherein the movement limitation means is configured to release the head of the living being again which is tilted with respect to the torso and thus limited in its range of movement, in response to the movement enable signal.

13. The device according to claim 1, further comprising:
a means for determining a distance between the movement limitation means and a remote control for transmitting the movement limitation signal.

14. The device according to claim 13, wherein the means for determining the distance is configured to trigger the movement limitation signal in response to a determined distance which is greater than a pre-determinable maximum distance.

15. The device according to claim 1, wherein the living being is a dog.

16. A set for limiting a freedom of movement of a living being, comprising:
a device for limiting a freedom of movement, comprising
a movement limitation means attachable to the torso of the living being and coupleable to a head of the living being by means of a coupling element; and
a receiving means for a movement limitation signal;
the movement limitation means being configured to tilt and/or rotate the head of the living being with respect to the torso of the living being by means of the coupling element in response to the movement limitation signal;
a head harness attachable to the head of the living being and comprising a coupling means for the coupling element; and
a remote control for triggering the movement limitation signal.

17. A method of limiting a freedom of movement of a living being, comprising:
transmitting a movement limitation signal to a designated receiver of a movement limitation means attached to the torso of the living being which is coupled to the head of the living being by means of a coupling element; and
tilting and/or rotating the head of the living being with respect to its torso by means of the movement limitation means and the coupling element in response to the movement limitation signal.
